(19) United States
(12) Patent Application Publication
(10) Pub. No.: US 2024/0419949 A1
(43) Pub. Date: Dec. 19, 2024

(54) INPUT-BASED ATTRIBUTION FOR CONTENT GENERATED BY AN ARTIFICIAL INTELLIGENCE (AI)

(71) Applicant: Sureel Inc., PACIFICA, CA (US)

(72) Inventors: Tamay AYKUT, Pacifica, CA (US); Christopher Benjamin KUHN, Munich (DE)

(73) Assignees: Sureel Inc., PACIFICA, CA (US); Sureel Inc., Pacifica, CA (US)

(21) Appl. No.: 18/231,551

(22) Filed: Aug. 8, 2023

Related U.S. Application Data
(60) Provisional application No. 63/521,066, filed on Jun. 14, 2023.

(51) Int. Cl. G06N 3/0475; G06N 3/0455; G06Q 30/0208

(52) U.S. Cl. CPC G06N 3/0475; G06N 3/0455; G06Q 30/0208

(57) ABSTRACT

In some aspects, a server determines an input provided to a generative artificial intelligence, parses the input to determine: a type of content to generate, a content description, and creator identifiers. The server embeds the input into a shared language-image space to create an input embedding. The server determines a creator description comprising a creator-based embedding associated with individual creators. The server performs a comparison of the input embedding to the creator-based embedding associated with individual creators to determine a distance measurement of an embedding of individual creators in the input embedding. The server determines creator attributions based on the distance measurement and creates a creator attribution vector to provide compensation to the creators.

### CROSS-REFERENCE TO RELATED APPLICATIONS

The present non-provisional patent application claims priority from U.S. Provisional Application 63/521,066 filed on Jun. 14, 2023, which is incorporated herein by reference in entirety and for all purposes as if completely and fully set forth herein.

### BACKGROUND OF THE INVENTION

### Field of the Invention

This invention relates generally to systems and techniques to determine the proportion of content items used by an artificial intelligence (e.g., Latent Diffusion Model) to generate derivative content, thereby enabling attribution (and compensation) to content creators that created the content items used to generate the derivative content.

### Description of the Related Art

Generative artificial intelligence (AI) enables anyone (including non-content creators) to instruct the AI to create derivative content that is similar to (e.g., shares one or more characteristics with) (1) content that was used to train the AI, (2) content used by the AI to create the new content, or (3) both. For example, if someone requests that the AI generate an image of a particular animal (e.g., a tiger) in the style of a particular artist (e.g., Picasso), then the AI may generate derivative content based on (1) drawings and/or photographs of the particular animal and (2) drawings of the particular artist. Currently, there is no means of determining the proportionality of the content that the AI used to generate the derivative content and therefore no mechanism to provide attribution (and compensation) to the content creators that created the content used by the AI to generate the derivative content.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some aspects, a server determines an input provided to a generative artificial intelligence, parses the input to determine: a type of content to generate, a content description, and creator identifiers. The server embeds the input into a shared language-image space to create an input embedding. The server determines a creator description comprising a creator-based embedding associated with individual creators. The server performs a comparison of the input embedding to the creator-based embedding associated with individual creators to determine a distance measurement (e.g., expressing a similarity) of an embedding of individual creators in the input embedding. The server determines creator attributions based on the distance measurement and creates a creator attribution vector to provide compensation to the creators.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system illustrating different ways to determine a attribution of an output of a generative artificial intelligence (AI), according to some embodiments.

FIG. 2 is a block diagram of a system to train an artificial intelligence (AI) on a particular content creator, according to some embodiments.

FIG. 3 is a block diagram of a system to perform input-based attribution, according to some embodiments.

FIG. 4 is a block diagram of a system to determine attribution based on analyzing an input to an artificial intelligence (AI), according to some embodiments.

FIG. 5 is a flowchart of a process that includes determining a distance measure between a content description and individual creator descriptions, according to some embodiments.

FIG. 6 is a flowchart of a process to train a machine learning algorithm, according to some embodiments.

FIG. 7 illustrates an example configuration of a computing device that can be used to implement the systems and techniques described herein.

### DETAILED DESCRIPTION

With conventional art (e.g., paintings), the term provenance refers to authenticating a work of art by establishing the history of ownership. More broadly, provenance is a set of facts that link the work of art to its creator and explicitly describe the work of art including, for example, a title of the work of art, a name of the creator (e.g., artist), a date of creation, medium (e.g., oil, watercolor, or the like), dimensions, and the like. Generative artificial intelligence (AI), implemented using, for example, a diffusion model, may be used to generate digital art. For example, a user (e.g., a secondary creator) may input a text description of the desired digital art to the AI and the AI may generate an output. To illustrate, the input “create a painting of a lion in the style of Picasso” may result in the generative AI creating a digital artwork that is derived from a picture of a lion and from the paintings of artist Pablo Picasso. The term provenance, as used herein, is with reference to digital art generated by an AI and includes attribution to one or more content creators (e.g., Picasso).

Terminology. As used herein, the term creator refers to a provider of original content (“content provider”), e.g., content used to train (e.g., fine tune or further train) the generative AI to encourage an “opt-in” mentality. By opting in to allow their original content to be used to train and/or re-train the generative AI, each of the creators receive attribution (and compensation) for derivative content created by the generative AI that has been influenced by the original content of the creators. The term user (a secondary creator) refers to an end user of the generative AI that generates derivative content using the generative AI.

The systems and techniques described herein may be applied to any type of generative AI models, including (but not limited to) diffusion models, generative adversarial network (GAN) models, Generative Pre-Trained Transformer (GPT) models, or other types of generative AI models. For illustration purposes, a diffusion model is used as an example of a generative AI. However, it should be understood that the systems and techniques described herein may be applied to other types of generative AI models. A diffusion model is a generative model used to output (e.g., generate) data similar to the training data used to train the generative model. A diffusion model works by destroying training data through the successive addition of Gaussian noise, and then learns to recover the data by reversing the noise process. After training, the diffusion model may generate data by passing randomly sampled noise through the learned denoising process. In technical terms, a diffusion model is a latent variable model which maps to the latent space using a fixed Markov chain. This chain gradually adds noise to the data in order to obtain the approximate posterior q (x1: T|x0), where x1, . . . , xT are latent variables with the same dimensions as x0.

A latent diffusion model (LDM) is a specific type of diffusion model that uses an auto-encoder to map between image space and latent space. The diffusion model works on the latent space, making it easier to train. The LDM includes (1) an auto-encoder, (2) a U-net with attention, and (3) a Contrastive Language Image Pretraining (CLIP) embeddings generator. The auto-encoder maps between image space and latent space. In terms of image segmentation, attention refers to highlighting relevant activations during training. By doing this, computational resources are not wasted on irrelevant activations, thereby providing the network with better generalization power. In this way, the network is able to pay “attention” to certain parts of the image. A CLIP encoder may be used for a range of visual tasks, including classification, detection, captioning, and image manipulation. A CLIP encoder may capture semantic information about input observations. CLIP is an efficient method of image representation learning that uses natural language supervision. CLIP jointly trains an image encoder and a text encoder to predict the correct pairings of a batch of (image, text) training examples. The trained text encoder synthesizes a zero-shot linear classifier by embedding the names or descriptions of the target dataset's classes. For pre-training, CLIP is trained to predict which possible (image, text) pairings actually occurred. CLIP learns a multi-modal embedding space by jointly training an image encoder and text encoder to maximize the cosine similarity of the image and text embeddings of the real pairs in the batch while minimizing the cosine similarity of the embeddings of the incorrect pairings.

As an example, a server includes one or more processors and a non-transitory memory device to store instructions executable by the one or more processors to perform various operations. For example, the operations include determining an input provided to a generative artificial intelligence to generate an output and parsing the input to determine: a type of content to generate, a content description, and one or more creator identifiers. For example, the generative artificial intelligence may be a latent diffusion model (LDM). The content description may include: (1) a noun comprising a name of a living creature, an object, a place, or any combination thereof and (2) zero or more adjectives to qualify the noun. The operations include embedding the input into a shared language-image space using a transformer to create an input embedding. The operations include determining a creator description comprising a creator-based embedding associated with individual creators identified by the one or more creator identifiers. For example, to create the creator description, the server may select a particular creator of the one or more creators, perform an analysis, using a neural network, of content items created by the particular creator, determine, based on the analysis, a plurality of captions describing the content items, and create, based on the plurality of captions, a particular creator description associated with the particular creator. The neural network may be implemented using a Contrastive Language Image Pretraining (CLIP) encoder. The operations include performing a comparison of the input embedding to the creator-based embedding associated with individual creators. The operations include determining, based on the comparison, a distance measurement (e.g., expressing a similarity) of an amount of an embedding of the individual creators in the input embedding. For example, the distance measurement may include: a cosine similarity, contrastive learning (e.g., self-supervised learning), a simple matching coefficient, a Hamming distance, a Jaccard index, an Orchini similarity, a Sorensen-Dice coefficient, a Tanimoto distance, a Tucker coefficient of congruence, a Tversky index, or any combination thereof. The operations include determining one or more creator attributions based on the distance measurement of the amount of the embedding of the individual creators in the input embedding. The operations include determining a creator attribution vector that includes the one or more creator attributions. The operations include initiating providing compensation to one or more creators based on the creator attribution vector. For example, the one or more creators may include (i) one or more artists, (ii) one or more authors, (iii) one or more musicians, (iv) one or more videographers, or (v) any combination thereof. When the type of content comprises a digital image having an appearance of a work of art, the one or more creators may comprise one or more artists. When the type of content comprises a digital text-based book, the one or more creators may comprise one or more authors. When the type of content comprises a digital music composition, the one or more creators may comprise one or more musicians. When the type of content comprises a digital video, the one or more creators may comprise one or more videographers.

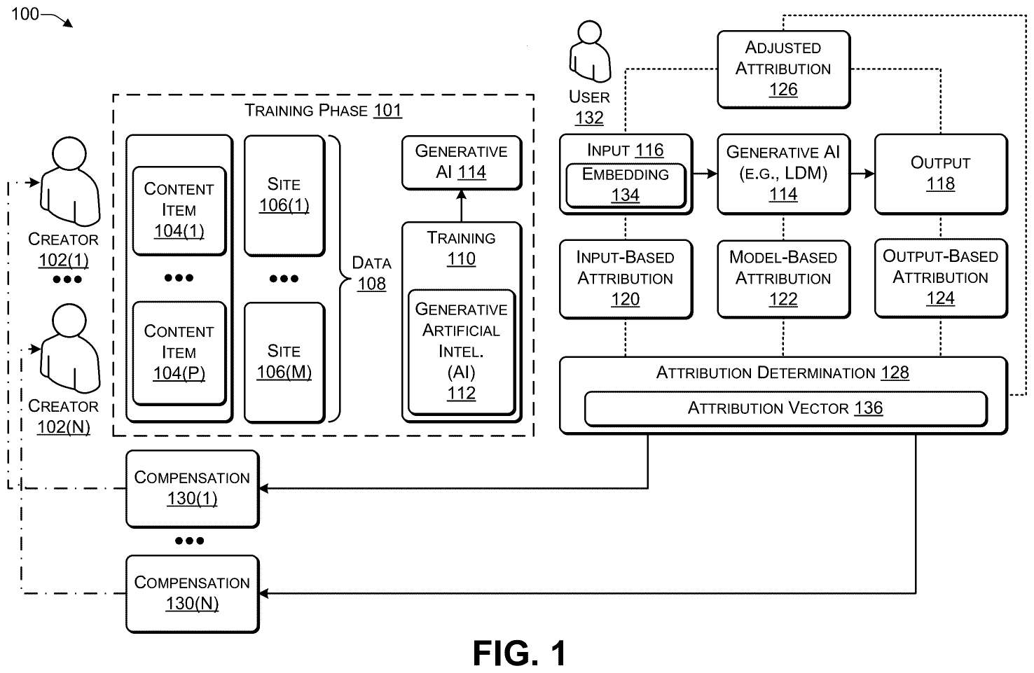

FIG. 1 is a block diagram of a system 100 illustrating different ways to determine a attribution of an output of a generative artificial intelligence (AI), according to some embodiments. Before a generative AI is deployed, the generative AI undergoes a training phase 101 in which the generative AI is trained using content.

Multiple creators 102(1) to 102(N) (N>0) may create content items 104(1) to 104(P) (P>0). The content items 104 may include, for example, digital artwork, digital music, digital text-based content (e.g., eBooks), digital photographs, digital video, another type of digital content, or any combination thereof. In some cases, at least a portion of the content items 104 may be accessible via one or more sites 106(1) to 106(M) (M>0). For example, the creators 102 may upload one or more of the content items 104 to one or more of the sites 106. For example, one or more of the content items 104 may be available for acquisition (e.g., purchase, lease, or the like) on the sites 106. In this example, the content items 104 may be gathered from the sites 106 and used as training data 108 to perform training 110 of a generative artificial intelligence 112 (e.g., pre-trained) to create a generative AI 114 (e.g., trained). For example, the generative AI 114 may be a latent diffusion model or similar. A generative AI, such as the AI 112, typically comes pre-trained after which further training (the training 110) is performed to create the AI 114. To illustrate, if the training 110 uses images of paintings, then the pre-trained AI 112 may be trained to generate images of paintings, if the training 110 uses rhythm and blues songs, then the pre-trained AI 112 may be trained to create the AI 114 that generates rhythm and blues songs, and so on.

After the generative AI 114 has been created, a user, such as a representative user 132 (e.g., secondary creator), may use the generative AI 114 to generate derivative content. For example, the representative user 132 may provide input 116, such as input, e.g., “create <content type> <content description> similar to <creator identifier>”. In this example, <content type> may include digital art, digital music, digital text, digital video, another type of content, or any combination thereof. The <content description> may include, for example, “a portrait of a woman with a pearl necklace”, “a rhythm and blues song”, “a science fiction novel”, “an action movie”, another type of content description, or any combination thereof. The <creator identifier> may include, for example, “Vermeer” (e.g., for digital art), “Aretha Franklin” (e.g., for digital music), “Isaac Asimov” (e.g., for science fiction novel), “James Cameron” (e.g., for action movie), or the like. The input 116 may be text-based input, one or more images (e.g., drawings, photos, or other types of images), or input provided using one or more user-selectable settings.

The input 116 may be converted to an embedding 134 prior to the generative AI 114 processing the input 116. Based on the input 116 and the embedding 134, the generative AI 114 may produce output 118. For example, the output 118 may include digital art that includes a portrait of a woman with a pearl necklace in the style of Vermeer, digital music that includes a rhythm and blues song in the style of Aretha Franklin, a digital book that includes a science fiction novel in the style of Isaac Asimov, a digital video that includes an action movie in the style of James Cameron, and so on. The input 116 is converted into the embedding 134 to enable the generative AI 114 to understand and process the input 116. Typically, the embedding 134 is a set of numbers, often arranged in the form of a vector. In some cases, the embedding 134 may use a more complex arrangement of numbers, such as a matrix (a vector is a one-dimensional form of a matrix).

Attribution for the derivative content in the output 118 may be performed in one of several ways. Input-based attribution 120 involves analyzing the input 116 and, in some cases, the embedding 134, to determine the attribution of the output 118. Model-based attribution 122 may create an attribution vector 136 that specifies a percentage of influence that each image, creator, pool, and/or category had in the training of the generative AI 114. For example:

$$Vector 136 = \{ SC 1 , SC 2 , … SCn \}$$

where SCi(0<i<=n) is a distance (e.g., similarity) of the content created by Creator 102(i) to the output 118 determined based on an analysis of the input 116. A distance between two items, such as a generated item and a content item, is a measure of a difference between the two items. As distance decreases, similarity between two items increases and as distance increases, similarity between two items decreases. For example, if a distance d between two items I1 and I2 is less than or equal to a threshold T, then the items are considered similar and if d>T, then the items are considered dissimilar. Output-based attribution 124 involves analyzing the output 118 to determine the main X(X>0) influences that went into the output 118. Adjusted attribution 126 involves manual fine tuning of the generative process by specifying a desired degree of influence for each content item, artist, pool, category (e.g., the data 108) that the generative AI 114 was trained on. Adjusted attribution 126 adjusting the output 118 images by either modifying an amount of influence that individual content item, creators, pools, categories have. For example, adjusted attribution 126 enables the user 132 to increase the influence of creator 102(N), which causes the generative AI 114 to generate the output 118 that includes content with a greater amount of content associated with creator 102(N).

One or more of: (i) the input-based attribution 120, (ii) the model-based attribution 122, (iii) the output-based attribution 124, or (iv) the adjusted attribution 126 (or any combination thereof) may be used by an attribution determination module 128 to determine an attribution for the content creators 102 that influenced the output 118. In some cases, the attribution determination 128 may use a threshold to determine how many of the creators 102 are to be attributed. For example, the attribution determination 128 may use the top X(X>0), such as the top five, top 8, top 10, or the like influences, to determine which of the creators 102 to attribute. As another example, the attribution determination 128 may identify one or more of the creators 102 that contributed at least a threshold amount, e.g., Y %, such as 5%, 10%, or the like. The attribution determination module 128 may determine attribution that is used to provide compensation 130 to one or more of the creators 102. For example, attribution determination module 128 may determine that a first creator 102 is to be attributed 40%, a second creator 102 is to be attributed 30%, a third creator 102 is to be attributed 20%, and a fourth creator is to be attributed 10%. The compensation 130 provided to one or more of the creators 102 may be based on the attribution determination. For example, the compensation 130 may include providing a statement accompanying the output 118 identifying the attribution (“this drawing is influenced Vermeer”, “this song is influenced by Aretha”, “this novel is influenced by Asimov”, and so on), compensation (e.g., monetary or another type of compensation), or another method of compensating a portion of the creators 102 whose content items 104 were used to generate the output 118.

Thus, the user 132 may use the generative AI 114 (e.g., implemented using LDM or similar) to synthesize the output 118 that includes derivative content (e.g., realistic-looking images) from scratch by providing input 116. In some cases, the output 118 may be similar to the training data 108 used to train the generative AI 112 to create the (fully trained) generative AI 114. In other cases, the output 118 may be different from the training data 108 used to train the AI 112 to create the generative AI 114. For example, the generative AI 114 may be trained using images of a particular person (or a particular object) and used to create new images of that particular person (or particular object) in contexts different from the training images. The generative AI 114 may apply multiple characteristics (e.g., patterns, textures, composition, color-palette, and the like) of multiple style images to create the output 118. The generative AI 114 may apply a style that is comprehensive and includes, for example, patterns, textures, composition, color-palette, along with an artistic expression (e.g., of one or more of the creators 102) and intended message/mood (as specified in the input 116) of multiple style images (from the training data 108) onto a single content image (e.g., the output 118). Application of a style learned using private images (e.g., provided by the user 132) is expressed in the output 118 based on the text included in the input 116. In some cases, the output 118 may include captions that are automatically generated by the generative AI 114 using a machine learning model, such as Contrastive Language-Image Pre-Training (CLIP), if human-written captions are unavailable. In some cases, the user 132 (e.g., secondary creator) may instruct the generative AI 114 to produce a ‘background’ of an image based on a comprehensive machine-learning-based understanding of the background of multiple training images to enable the background to be set to a transparent layer or to a user-selected color. The generative AI 114 may be periodically retrained to add new creators, to add new content items of creators previously used to train the generative AI 114, and so on.

The output 118 may be relatively high resolution, such as, for example, 512 pixels (px), 768px, 2048px, 3072px, or higher and may be non-square. For example, the user 132 may specify in the input 116 a ratio of the length to width of the output 118, such as 3:2, 4:3, 16:9, or the like, the resolution (e.g., in pixels) and other output-related specifications. In some cases, the output 118 may apply a of style to videos with localized synthesis restrictions using a prior learned or explicitly supplied style.

In some cases, the model-based attribution 122 may create the attribution vector 136 for content generation of the generative AI 114, which may be an “off the shelf” LDM or an LDM that has been fine-tuned specifically for a particular customer (e.g., the user 132). The attribution vector 136 specifies the percentage of influence that each content item, creator, pool, category had in the creation of the generative AI 114 (e.g., LDM). The model-based attribution 122 may create an output-based attribution vector for the output 118 with a specific text/as input 116. In some cases, the attribution vector may specify the percentage of influence that each content item, creator, pool, category had in the creation of the output 118 based on the specific text in the input 116.

The input-based attribution 120 may create an input-based attribution vector 136 for a specific output 118, e.g., generated content, that was generated by providing text t as input 116. The attribution vector 136 specifies the percentage of relevance each content item, creator, pool, category has based on the input 116. The input 116 may reveal influences, regardless of the type of generative model used to generate the output 118. The input-based attribution 120 may analyze the input 116 to identify various components that the generative AI 114 uses to create the output 118.

First, the input-based attribution 120 may analyze the input 116 to determine creator identifiers (e.g., creator names) that identify one or more of the creators 102. For example, if a particular creator of the creators 102 (e.g., Picasso, Rembrandt, Vermeer, or the like for art) is explicitly specified in the input 116, then the bias of the particular creator is identified by adding the particular creator to the attribution vector 136.

Second, the input-based attribution 120 may analyze the input 116 to determine one or more categories, such as specific styles, objects, or concepts, in the input 116. The input-based attribution 120 may determine a particular category in the input 116 and compare the particular category with categories included in descriptions of individual creators 102. To illustrate, if the input 116 has the word “dog” (a type of category), then “dog” (or a broader category, such as “animal”) may be used to identify creators 102 (e.g., Albrecht Dürer, Tobias Stranover, Carel Fabritius, or the like) who are described as having created content items 104 that include that type of category (e.g., “dog” or “animal”). To enable such a comparison, a description Dj is created and maintained for each creator Cj, where each description contains up to k (k>0) categories. The description may be supplied by the creator or generated automatically using a machine learning model, such as CLIP, to identify which categories are found in the content items 104 created by the creators 102. The descriptions of creators 102 may be verified (e.g., using a machine learning model) to ensure that the creators 102 do not add categories to their descriptions that do not match their content items 104.

Third, the input-based attribution 120 may determine the embedding 134. To generate the output 118 from the input 116, the input 116 (e.g., text/) may be embedded into a shared language-image space using a transformer to create the embedding 134 (Et). The embedding 134 (Et) may be compared to creator-based embeddings ECi to determine the distance (e.g., similarity) of the input 116 to individual creators 102. A distance measurement (e.g., expressing a similarity) may be determined using a distance measure Di, such as cosine similarity, contrastive learning (e.g., self-supervised learning), Orchini similarity, Tucker coefficient of congruence, Jaccard index, Sorensen similarity index, or another type of distance or similarity measure. In some cases, the resulting input-based attribution 120 may be combined with the attribution of the output 118 Of which is generated from the embedding 134 (Et) using the input text/using a transformer T. At an output-level, the embeddings ECi may be compared to the training data 108.

The adjusted attribution 126 enables the user 132 (e.g., secondary creator) to re-adjust the generative process by specifying a desired degree of influence for each content item, creator, pool, category in the training data 108 that was used to train the generative AI 114 when creating the output 118. This enables the user 132 to “edit” the output 118 by repeatedly adjusting the content used to create the output 118. For example, the user 132 may adjust the attribution by increasing the influence of creator 102(N) and decreasing the influence of creator 102(1) in the output 118. Increasing creator 102(N) results in instructing the generative AI 114 to increase an embedding of creator 102(N) in the output 118, resulting in the output 118 have a greater attribution to creator 102(N).

The output-based attribution 124 creates an output-based attribution vector 136, e.g., for style transfer synthesis and for using the content and style images to adjust the attribution vector, e.g., by increasing the element in the attribution vector corresponding to the creator 102 who created the style images. The degree of influence for the generative AI 114 may also be manually adjusted, as described herein, using the adjusted attribution 126.

Thus, an AI may be trained using content to create a generative AI capable of generating derivative content based on the training content. The user may provide input, in the form of a description describing the desired output, to the generative AI. The generative AI may use the input to generate an output that includes derivative content derived from the training content. When using input-based attribution, the input may be analyzed to identify creator identifiers and content identifiers. The creator identifiers may be used to identify a description of the creators. An attribution determination module may use the description of the creators to determine an attribution vector that indicates an amount of attribution for individual creators. For example, the attribution determination module may compare (i) embeddings of individual creators in the input with (ii) the description of the creators to determine a distance measurement (e.g., similarity) between the input provided to the generative AI and the description of individual creators. The distance measurement may be used to determine the creator attribution.

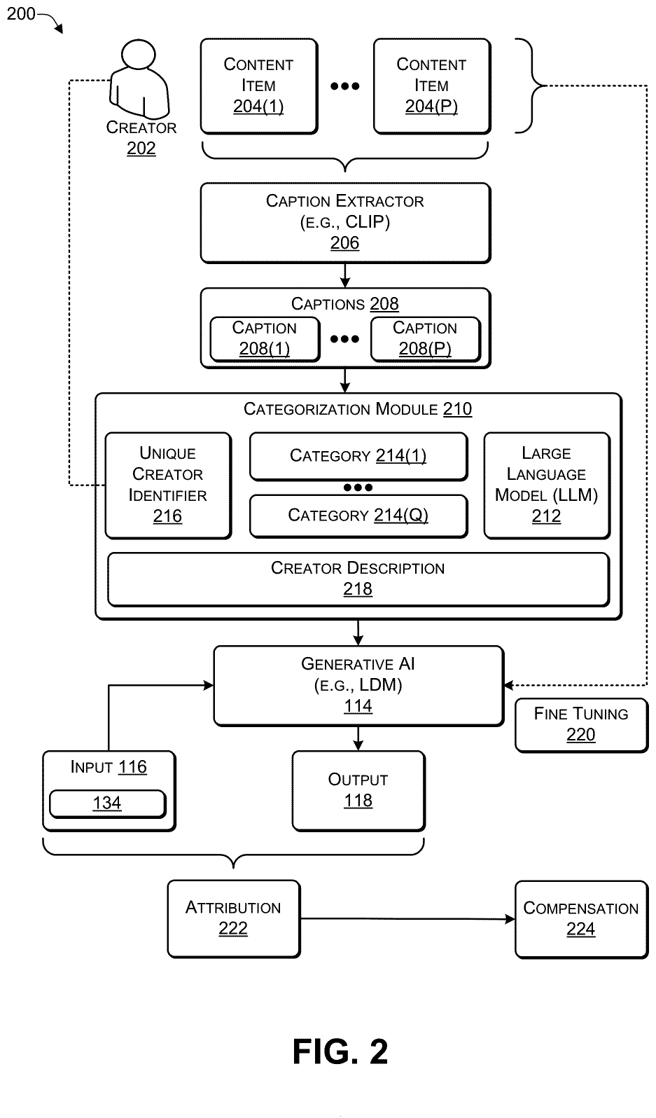

FIG. 2 is a block diagram of a system 200 to train an artificial intelligence (AI) on a particular content creator, according to some embodiments. A creator 202 (e.g., one of the creators 102 of FIG. 1) may create one or more content items 204(1) to 204(P) (P>0) (e.g., at least a portion of the content items 104 of FIG. 1).

A caption extractor 206 is used to create captions 208, caption 208(1) describing content item 204(1) and caption 208(P) describing content item 204(P). The caption extractor 206 may be implemented using, for example, a neural network such as Contrastive Language Image Pre-training (CLIP), which efficiently learns visual concepts from natural language supervision. CLIP may be applied to visual classification, such as art, images (e.g., photos), video, or the like.

The categorization module 210 is used to identify categories 214(1) to 214(Q) based on the caption 208 associated with each content item. For example, a visual image of a dog and the cat on a sofa may result in the captions “dog”, “cat”, “sofa”. The categorization module 210 may use a large language model 212 to categorize the captions 208. For example, dog and cat may be placed in an animal category 214 and sofa may be placed in a furniture category 214. A unique creator identifier 216 may be associated with the creator 202 to uniquely identify the creator 202. In this way, the categorization module 210 may create a creator description 218 associated with the unique creator identifier 216. The creator description 218 may describe the type of content items 204 that the creator 202 creates. For example, the categorization module 210 may determine that the creator 202 creates images (e.g., photos or artwork) that include animals and furniture and indicate this information in the creator description 218.

The generative AI 114 may use the input 116 to produce the output 118. The output 118 may be compared with the content items 204. In some cases, fine tuning 220 may be performed to further improve the output of the generated AI 114 to enable the output 118 to closely resemble one or more of the content items 204. An attribution module 222, such as the input-based attribution 120, the model-based attribution 122, the output-based attribution 124, the adjusted attribution 126 or any combination thereof, may be used to determine the attribution and provide compensation 224 to the creator 202.

Thus, an AI may be trained on a particular creator by taking content items created by the creator, analyzing the content items to extract captions, and using a categorization module to categorize the captions into multiple categories, using a large language model. The particular creator may be assigned a unique creator identifier and the unique creator identifier may be associated with the creator description created by the categorization module based on the captions. The output of the generative AI may be fine-tuned to enable the generative AI to produce output that more closely mimics the content items produced by the creator.

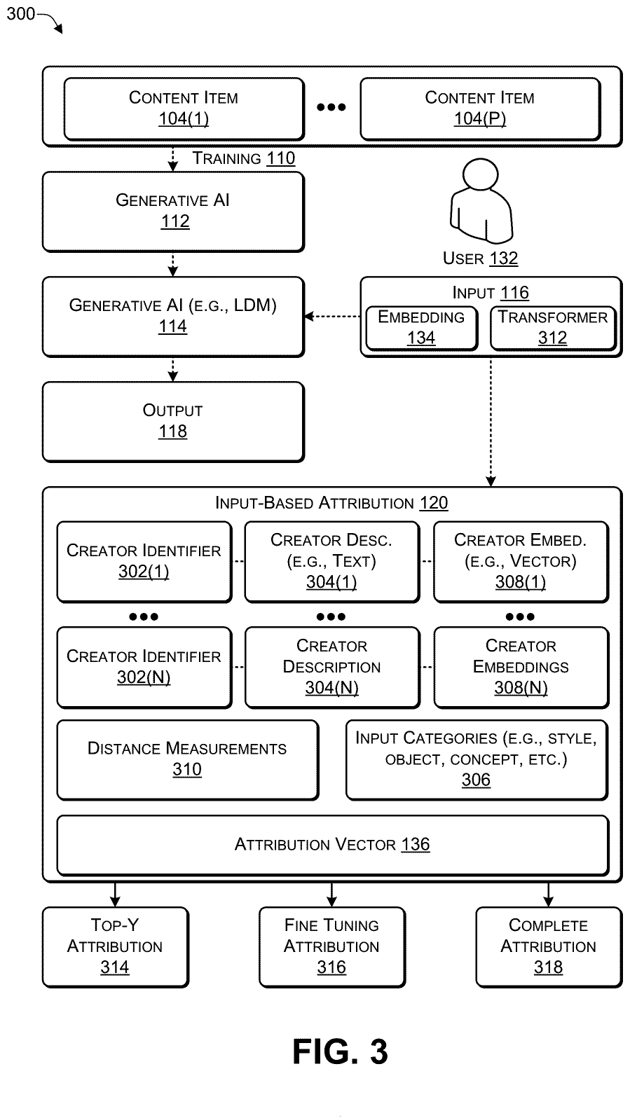

FIG. 3 is a block diagram of a system 300 to perform input-based attribution, according to some embodiments. The input-based attribution 120 may create the attribution vector 136 for the output 118 (e.g., derivative content) that was generated by providing text/in the input 116. The attribution vector 136 specifies an amount (e.g., a percentage) of relevance each content item, creator, pool, category, and the like has on the output 118 based on analyzing the input 116. Analyzing the input 116 determines the influences for the output 118, regardless of the type of generative model used to generate the output 118. The input-based attribution 120 analyzes the input 116 to determine the following three things.

First, the input-based attribution 120 analyzes the input 116 to determine creator identifiers (e.g., creator names) 302(1) to 302(N), corresponding to creators 102(1) to 102(N), respectively. The creator identifiers 302 identify one or more of the creators 102. For example, if a particular creator 102(X) (0<X<=N) of the creators 102 is explicitly specified in the input 116, then the particular creator 102(X) may be added to the attribution vector 136. For example, if the input 116 includes the creator identifiers “Degas” and “Dali” then both creators are added to the attribution vector 136.

Second, the input-based attribution 120 may analyze the input 116 to determine one or more input categories 306, such as particular styles, objects, concepts, or the like in the input 116. For each particular category of the input categories 306 identified in the input 116, the input-based attribution compares the particular category with categories included in creator descriptions 304(1) to 304(N) corresponding to the creators 102(1) to 102(N), respectively. To illustrate, if the input 116 has the word “dog” (a category), then “dog” (or a broader category, such as “animal”) may be used to identify creators 102 (e.g., Albrecht Dürer, Tobias Stranover, Carel Fabritius, or the like) whose creator descriptions 304 include that type of category (e.g., “dog” or “animal”). For example, “pearl necklace” in the input 116 may be categorized as “jewelry” and searching the creator descriptions 304 may identify the creator identifier 302 corresponding to Johannes Vermeer, who painted “Girl With A Pearl Earring”. To enable such a comparison, the creator descriptions 304(1) to 304(N), corresponding to creators 102(1) to 102(N), respectively, are created and maintained for individual creators 102. Each creator description 304 contains up to k (k>0) categories. Individual creator descriptions 304 may be supplied by the corresponding creator 102, e.g., the creator description 304(N) is provided by creator 102(N), or generated automatically using machine learning (e.g., such as the caption extractor 206 of FIG. 2). The individual creator descriptions 304 identify which categories are found in the content items 104 created by individual creators 102. The creator descriptions 304 of individual creators 102 may be verified (e.g., using a machine learning model) such as the caption extractor 206) to verify that the individual creators 102 have not added categories to their corresponding creator descriptions 304 that do not match their associated content items 104.

Third, the input-based attribution 120 may determine the embedding 134. To generate the output 118 from the input 116, the input 116 (e.g., text 1) may be embedded into a shared language-image space using a transformer 312 to create the embedding 134(Et). The embedding 134 (Et) may be compared to creator-based embeddings 308(1) to 308(N) (e.g., ECi) to determine a distance (e.g., similarity) of the input 116 to individual creators 102. A distance measurement may be determined using a distance measure Di, such as cosine similarity, Orchini similarity, Tucker coefficient of congruence, Jaccard index, Sorensen similarity index, contrastive learning (e.g., self-supervised learning), or another type of distance or similarity measure to create distance measurements 310. In some cases, the resulting input-based attribution 120 may be combined with the attribution of the output 118 (Ot) which is generated from the embedding 134 (Et) using the input 116 (text 1) using the transformer 312(T). At an output-level, the creator embeddings 308 (ECi) may be compared to the training data 108.

The input-based attribution 120 may determine one or more of the following attributions: (1) Top-Y attribution 314, (2) fine tuning attribution 316, (3) complete attribution 318, or (4) any combination thereof. Top-Y attribution determines an influence of the strongest Y contributors based on the input 116. Y may be pre-set (e.g., identify the top 5, Y=5) or may be based on a contribution greater than a threshold (e.g., identify the top Y having a contribution of 10% or more). Note that Y=1 produces the special case of single creator attribution. Fine-tuning attribution 316 determines the influence of small fine-tuning training set on input. For example, the attribution may not be determined for all training data, but instead may be determined using a smaller training set that is then used to fine-tune the generative AI (e.g., LDM). For example, a latent diffusion model (LDM), such as Stable Diffusion, is typically trained using approximately 6 billion images. When data associated with 100 artists is added, the generative AI may be fine-tuned to learn (and create content in the style of) the 100 artists. When the input 116 is used to create a new image, the input-based attribution 120 may be used to determine attribution to the 100 artists, even without attribution to the original 6 billion images used to initially train the generative AI. Complete attribution 318 determines the influence of every item 104 used in the training 110 on the input 116.

In this way, the input to a generative AI is analyzed to identify categories included in the input (also referred to as input categories). For example, the categories may be broader than what was specified in the input, such as a category “animal” (rather than cat, dog, or the like specified in the input), a category “furniture” (rather than sofa, chair, table, or the like specified in the input), a category “jewelry” (rather than earring, necklace, bracelet, or the like specified in the input) and so on. Each creator has a corresponding description that includes categories (also referred to as creator categories) associated with the content items created by each creator. For example, a creator who creates a painting of a girl with a necklace may have a description that includes categories such as “jewelry”, “girl”, “adolescent”, “female”, or the like. The creator categories may include the type of media used by each creator. For example, for art, the categories may include pencil drawings (color or monochrome), oil painting, watercolor painting, charcoal drawing, mixed media painting, and so on. The input-based attribution compares the categories identified in the input with the categories associated with each creator and determines a distance measurement for each category in the input. The distance measurements are then used to create an attribution vector that identifies an amount of attribution for each creator based on the analysis of the input.

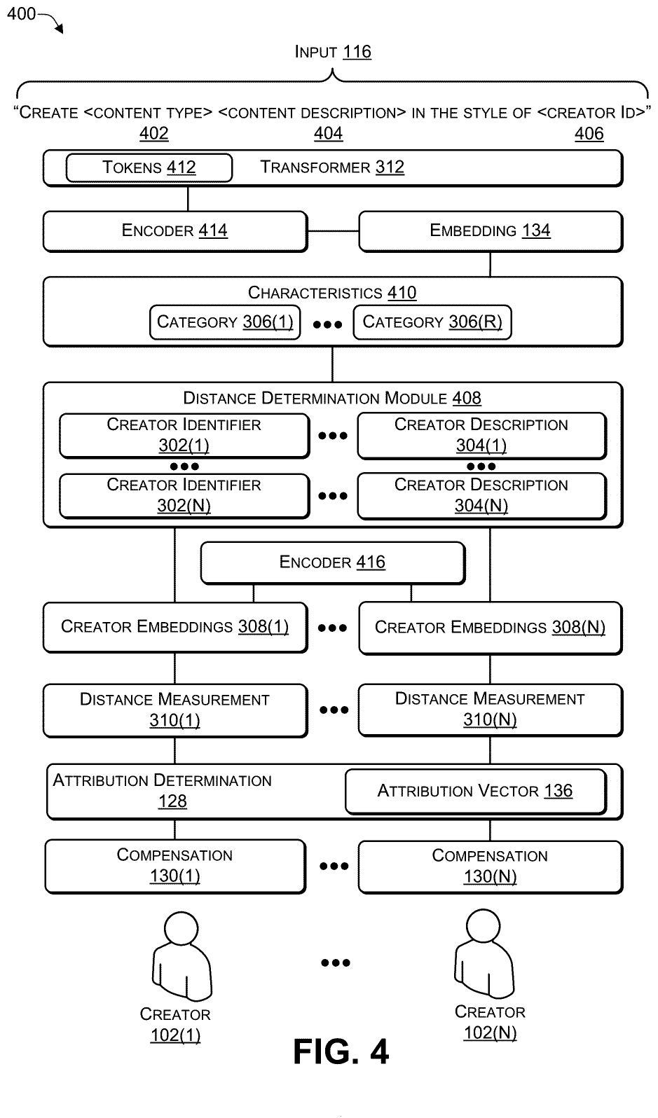

FIG. 4 is a block diagram of a system 400 to determine attribution based on analyzing an input to an artificial intelligence (AI), according to some embodiments. The system 400 describes components of the input-based attribution module 120 of FIG. 1 and FIG. 3.

The system 400 creates the attribution vector 136 based on the input 116. The attribution vector 136 determines an amount (e.g., a percentage) of relevance that each content item, creator, pool, category, and the like has (e.g., on the output 118) by analyzing the input 116. The input 116 may specify a content type 402, such as, for example a painting, a photo-like image, a musical piece, a video, a book (e.g., text alone or text and illustrations), or another type of content. The input 116 may specify a content description 404 that includes a noun and zero or more adjectives, such as “dog”, “Maltese puppy”, “25-year old Caucasian woman with long blonde hair”, or the like. The input 116 may specify at least one creator identifier (Id) 406 that includes at least one creator, such as, for example, “a reggae song in the style of Bob Marley with vocals in the style of Aretha Franklin” (in this example, the music is requested in the style of a first creator and the vocals in the style of a second creator), “an R&B song in the style of the band Earth, Wind, and Fire with vocals sounding like a combination between Prince and Michael Jackson”, and so on.

The system 400 analyzes the input 116 to determine creator identifiers (e.g., creator names) 302(1) to 302(N), corresponding to creators 102(1) to 102(N), respectively. The creator identifiers 302 identify one or more of the creators 102. If the system 400 determines that a particular creator 102(X) (0<X<=N) of the creators 102 is identified in the input 116, then the particular creator 102(X) may be added to the attribution vector 136. For example, if the input 116 includes the creator identifiers “Dali” and “Picasso” then both creators may be added to the attribution vector 136.

The system 400 analyzes the input 116 to determine one or more input categories 306(1) to 306(R) (R>0), such as particular styles (e.g., realistic, romantic, abstract, impressionistic, photo realistic, or the like), objects (e.g., man, woman, people, humans, animals, forest, jungle, furniture, indoors, outdoors, or the like), concepts, or the like in the input 116. “Concept” is an example of a less physical category of visual content. For example, to create an image depicting an idea (e.g., depict capitalism, depict stoicism, depict a dream, depict a voyage, or the like). In addition to “concept”, additional categories, such as color (e.g., greyscale, primary, bright, dull, diffuse) or mood (happy, angry, sad, inspiring) may also be used, e.g., “create a painting of a portrait of a woman with a stoic expression in the style of Rembrandt”. For each input-related category of the categories 306(identified in the input 116), the system 400 compares the input-related category with creator categories included in the creator descriptions 304(1) to 304(N), corresponding to the creators 102(1) to 102(N), respectively). To illustrate, if the input 116 has the word “dog” (a category), then “dog” (or a broader category, such as “animal”) may be used to identify creators 102 (e.g., Albrecht Dürer, Tobias Stranover, Carel Fabritius, or the like) whose creator descriptions 304 include that type of category (e.g., “dog” or “animal”). For example, “pearl necklace” in the input 116 may be categorized as “jewelry” and searching the creator descriptions 304 may identify the creator identifier 302 corresponding to Johannes Vermeer, who painted “Girl With A Pearl Earring”. To enable such a comparison, the creator descriptions 304(1) to 304(N), corresponding to creators 102(1) to 102(N), respectively, are created and maintained for individual creators 102. Each creator description 304 contains up to k (k>0) categories. Individual creator descriptions 304 may be supplied by the corresponding creator 102 (e.g., creator description 304(N) is provided by creator 102(N)) or generated automatically using machine learning (e.g., such as the caption extractor 206 of FIG. 2). The individual creator descriptions 304 identify which categories are found in the content items 104 created by individual creators 102. The creator descriptions 304 of individual creators 102 may be verified (e.g., using a machine learning model) such as the caption extractor 206) to verify that the individual creators 102 have not added categories to their corresponding creator descriptions 304 that do not match their associated content items 104.

The system 400 determines the embedding 134 corresponding to the input 116. To generate the output 118 from the input 116, the input 116 (e.g., text 1) may be embedded into a shared language-image space using the transformer 312 to create the embedding 134 (Et). A distance determination module 408 may compare the embedding 134 (Et) to creator embeddings 308(1) to 308(N) (e.g., ECi) to determine a distance (e.g., similarity) of the input 116 to individual creators 102. The distance determination module 408 determines a distance (e.g., similarity) using a distance measure Di, such as a cosine similarity, an Orchini similarity, a Tucker coefficient of congruence, a Jaccard index, a Sorensen similarity index, contrastive learning (e.g., self-supervised learning), or another type of distance or similarity measure, to create distance measurements 310(1) to 310(N) corresponding to the creators 102(1) to 102(N), respectively.

For example, assume the input 116 includes “create a painting of a woman in the style of both Picasso and Dali”. The input 116 may include either a caption or a prompt. A caption is text that describes an existing image, whereas a prompt is text that specifies a desired, but currently non-existent image. In this example, the text “create a painting of a woman in the style of Picasso and Dali” is a prompt, not a caption. To process the prompt (in the input 116), the text is converted into tokens 412. This may be viewed as one stage in a complex image synthesis pipeline. The tokens 412 are an encoding (e.g., representation) of the text to make the input 116 processable by a generative AI. For example, the space between words can be a token, as can be a comma separating words. In a simple case, each word, each punctuation symbol, and each space may be assigned a token. However, a token can also refer to multiple words, or to multiple syllables within a word. There are many words in a language (e.g., English). By grouping the words together to create the tokens 412, the result, as compared to the text in the input 116, is relatively few tokens (e.g., compression) with a relatively high-level meaning.

The tokens 412 may be processed using an encoder 414 to create the embedding 134. In this example, the text of the input 116 is converted into the embedding 134. In some cases, the embedding may be a vector, such as a vector of Y numbers (e.g., Y=512, 1024, or the like). Such a vector is an efficient way of storing the information from the input 116, e.g., “create a painting of a woman in the style of Picasso and Dali”. By converting a full English sentence into a vector of numbers enables the vector (e.g., the embedding 134) to be quickly and easily compared to other vectors. For example, a different encoder 416 may be used to embed content (e.g., images) into vectors of numbers as well. The encoder 414 turns the tokens 412 into a vector of numbers, a different encoder turns the content associated with each of the creators 102 into the creator embeddings 308. If Picasso and Dali were placed together in a room, told to paint a woman, and the a photograph of the resulting images were fed into the encoder 416, the resulting vector (creator embeddings 308) would be similar to the vector of numbers in the embedding 134. For example, a Contrastive Language-Image Pre-training (CLIP) may be used to create the embedding 134, 308. At its core, CLIP includes text and an image encoder. CLIP is an integral part of generative AI (such as Stable Diffusion) because CLIP performs the encoding of text during image synthesis and because CLIP encoded both text and images during training.

A caption, rather than a prompt, works the other way around. For example, given an image combining the paintings of two artists, an image embedding comprising a vector of numbers (e.g., 512 numbers) of the image may be decoded into the text “a painting of a woman in the style of Dali and Picasso”. Converting an image into a vector of numbers and then converting those numbers back into text is referred to as caption extraction.

A creator embedding of Picasso (e.g., 308(P)) and a creator embedding of Dali (e.g., 308(D)) are each vectors of numbers. Each creator embedding 308 may be created as follows. First, images of paintings painted by a creator (e.g., Picasso) are obtained and supplied to the encoder 416, with each image having a caption that includes “a painting by Picasso”. The encoder 416 turns both the painting and the associated caption into a vector of number, e.g., the creator embedding 308(P) associated creator Picasso. During the training phase 101 of FIG. 1, the generative AI 114 (e.g., Stable Diffusion) learns to properly reconstruct an image using a vector of numbers. By causing the generative AI 114 to reconstruct many (e.g., dozens, hundreds, or thousands) of images of Picasso paintings using just the vector of numbers (e.g., 512 numbers) derived from text, the generative AI 114 learns to map the word “Picasso” in the text input to a certain style in the images (e.g., in the output 118) created by the generative AI 114. After the training phase 101 has been completed, the generative AI 114 knows what is meant when the input 116 includes the text “Picasso”. From the training phase 101, the generative AI 114 knows exactly which numbers create the embedding 134 to enable generating any type of image in the style of Picasso. In this way, the creator embedding 308(P) associated with Picasso is a vector of numbers that represent the style of Picasso. A similar training process is performed for each creator, such as Dali.

In this way, the input to a generative AI is analyzed to identify categories included in the input (also referred to as input categories). In some cases, a distance determination module may determine categories that are broader (or narrower) than a particular category specified in the input. For example, cat, dog, or the like specified in the input may be broadened to the category “animal”. As another example, sofa, chair, table, or the like specified in the input may be broadened to the category “furniture”. As a further example, earring, necklace, bracelet, or the like specified in the input may be broadened to a category “jewelry”, and so on. Each creator has a corresponding description that includes categories (also referred to as creator categories) associated with the content items created by each creator. For example, a creator who creates a painting of a girl with a necklace may have a description that includes categories such as “jewelry”, “girl”, “adolescent”, “female”, or the like. The creator categories may include the type of media used by each creator. For example, for art, the categories may include pencil drawings (color or monochrome), oil painting, watercolor painting, charcoal drawing, mixed media painting, and so on. The distance determination module compares the categories identified in the input with the categories associated with each creator to determine a distance (e.g., similarity) measure for each category in the input. The distance measurements are used to create an attribution vector that identifies an amount of attribution for each creator based on the analysis of the input.

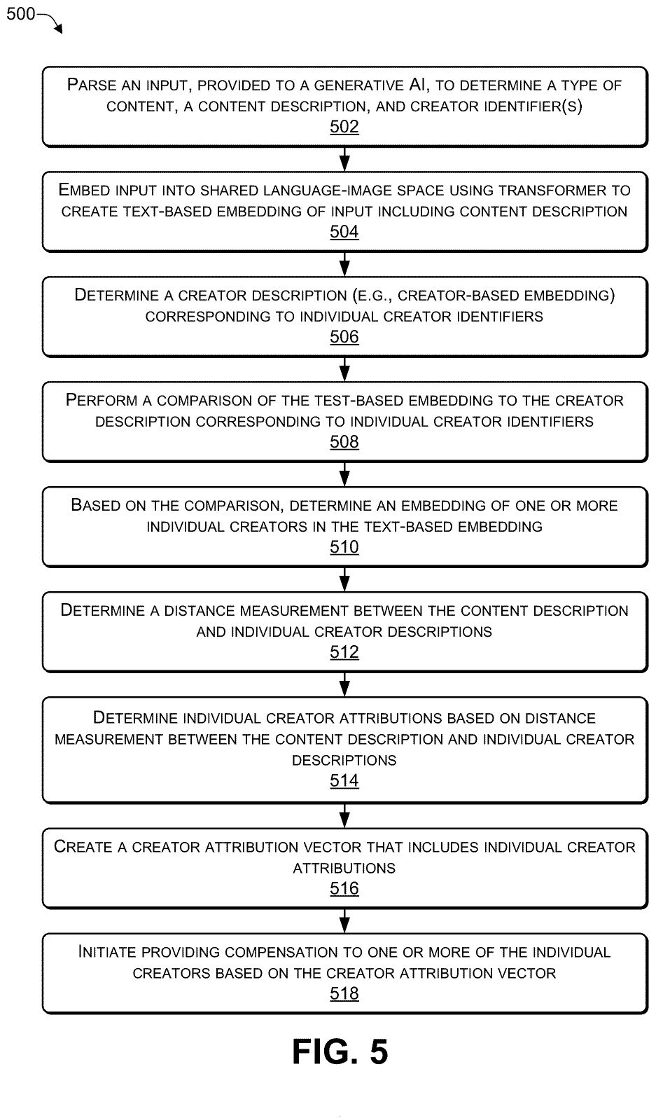

In the flow diagram of FIG. 5 each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process 500 is described with reference to FIGS. 1, 2, 3, and 4 as described above, although other models, frameworks, systems and environments may be used to implement these processes.

FIG. 5 is a flowchart of a process 500 that includes determining a distance measurement between a content description and individual creator descriptions, according to some embodiments. The process may be performed by the input-based attribution 120 of FIGS. 1 and 3 or one or more of the modules described in FIG. 4.

At 502, the process may parse an input, provided to a generative AI, to determine a type of content, a content description, and one or more creator identifiers. At 504, the process may embed the input into a shared language image space using a transformer to create an embedding of the content description. For example, in FIG. 4, the process may parse the input 116 to identify the content type CDII, the content description 44, and the at least one creator identifier 406. The process may use the transformer 312 to transform the input 116 into the embedding 134.

At 506, the process may determine a creator description (e.g. using a creator based embedding) corresponding to individual creator identifiers. For example, in FIG. 4, the process may use the at least one creator identifier 406 to look up the corresponding creator descriptions 304.

At 508, the process may perform a comparison of the content description categories to the creator description corresponding to individual creator identifiers. At 510, the process may, based on the comparison, determine an embedding of one or more individual creators in the embedding. At 512, the process may determine a distance measurement between the content description and individual creator descriptions. At 514, the process may determine individual creator attributions based on a distance measurement between the content description and individual creator descriptions. For example, in FIG. 4, the process may perform a comparison of the embedding 134 (including, for example, the categories 306) to the individual creator descriptions 304. Based on the comparison, the process may determine individual creator embeddings 308 present in the embedding 134 of the input 116. The process may determine distance measurements 310 between individual creator embeddings 308 and the embedding 134 (of the input 116).

At 516, the process may create a creator attribution vector that includes individual creator attributions. At 518, the process may initiate providing compensation to one or more of the individual creators based on the creator attribution vector. For example, in FIG. 4, the process may create the attribution vector 136 that includes attributions of individual creators 102 to an output produced by a generative AI based on the input 116. The attribution vector 136 may be used to provide compensation to one or more individual creators 102.

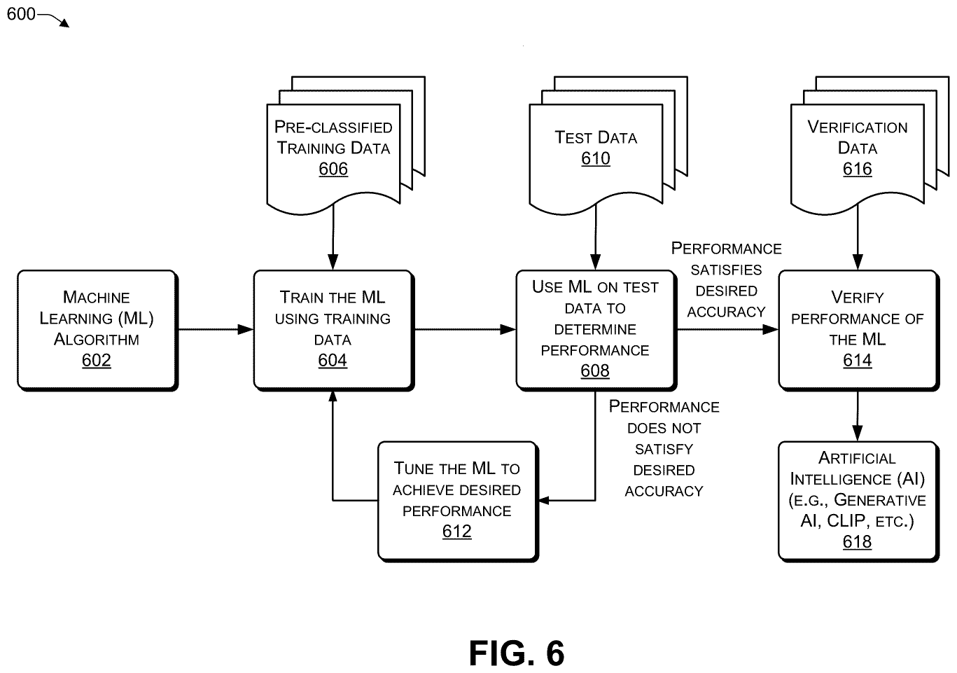

FIG. 6 is a flowchart of a process 600 to train a machine learning algorithm, according to some embodiments. For example, the process 700 may be performed during the training phase 101 of FIG. 1.

At 602, a machine learning algorithm (e.g., software code) may be created by one or more software designers. For example, the generative AI 112 of FIGS. 1 and 3 may be created by software designers. At 604, the machine learning algorithm may be trained using pre-classified training data 606. For example, the training data 606 may have been pre-classified by humans, by machine learning, or a combination of both. After the machine learning has been trained using the pre-classified training data 606, the machine learning may be tested, at 608, using test data 610 to determine a performance metric of the machine learning. The performance metric may include, for example, precision, recall, Frechet Inception Distance (FID), or a more complex performance metric. For example, in the case of a classifier, the accuracy of the classification may be determined using the test data 610.

If the performance metric of the machine learning does not satisfy a desired measurement (e.g., 95%, 98%, 99% in the case of accuracy), at 608, then the machine learning code may be tuned, at 612, to achieve the desired performance measurement. For example, at 612, the software designers may modify the machine learning software code to improve the performance of the machine learning algorithm. After the machine learning has been tuned, at 612, the machine learning may be retrained, at 604, using the pre-classified training data 606. In this way, 604, 608, 612 may be repeated until the performance of the machine learning is able to satisfy the desired performance metric. For example, in the case of a classifier, the classifier is able to classify the test data 610 with the desired accuracy.

After determining, at 608, that the performance of the machine learning satisfies the desired performance metric, the process may proceed to 614, where verification data 616 may be used to verify the performance of the machine learning. After the performance of the machine learning is verified, at 614, the machine learning 602, which has been trained to provide a particular level of performance may be used as an artificial intelligence (AI) 618. For example, the AI 618 may be the (trained) generative AI 114 of FIGS. 1, 2, and 3 or the caption extractor 206 (CLIP neural network) of FIG. 2.

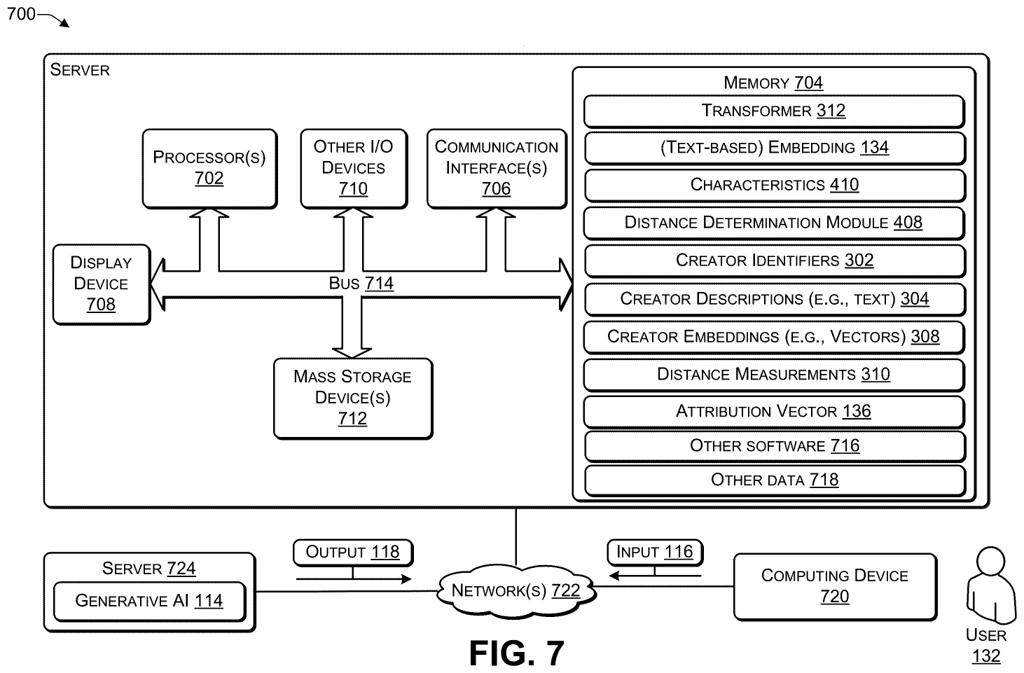

FIG. 7 illustrates an example configuration of a device 700 that can be used to implement the systems and techniques described herein. For example, the device 700 may be one or more servers used to host one or more of the components described in FIGS. 1, 2, 3, and 4. In some cases, the systems and techniques described herein may be implemented as an application programming interface (API), a plugin, or another type of implementation.

The device 700 may include one or more processors 702 (e.g., central processing unit (CPU), graphics processing unit (GPU), or the like), a memory 704, communication interfaces 706, a display device 708, other input/output (I/O) devices 710 (e.g., keyboard, trackball, and the like), and one or more mass storage devices 712 (e.g., disk drive, solid state disk drive, or the like), configured to communicate with each other, such as via one or more system buses 714 or other suitable connections. While a single system bus 714 is illustrated for ease of understanding, it should be understood that the system buses 714 may include multiple buses, such as a memory device bus, a storage device bus (e.g., serial ATA (SATA) and the like), data buses (e.g., universal serial bus (USB) and the like), video signal buses (e.g., ThunderBolt®, digital video interface (DVI), high definition media interface (HDMI), and the like), power buses, etc.

The processors 702 are one or more hardware devices that may include a single processing unit or a number of processing units, all of which may include single or multiple computing units or multiple cores. The processors 702 may include a graphics processing unit (GPU) that is integrated into the CPU or the GPU may be a separate processor device from the CPU. The processors 702 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 702 may be configured to fetch and execute computer-readable instructions stored in the memory 704, mass storage devices 712, or other computer-readable media.

Memory 704 and mass storage devices 712 are examples of computer storage media (e.g., memory storage devices) for storing instructions that can be executed by the processors 702 to perform the various functions described herein. For example, memory 704 may include both volatile memory and non-volatile memory (e.g., random access memory (RAM), read only memory (ROM), or the like) devices. Further, mass storage devices 712 may include hard disk drives, solid-state drives, removable media, including external and removable drives, memory cards, flash memory, floppy disks, optical disks (e.g., compact disc (CD), digital versatile disc (DVD), a storage array, a network attached storage (NAS), a storage area network (SAN), or the like. Both memory 704 and mass storage devices 712 may be collectively referred to as memory or computer storage media herein and may be any type of non-transitory media capable of storing computer-readable, processor-executable program instructions as computer program code that can be executed by the processors 702 as a particular machine configured for carrying out the operations and functions described in the implementations herein.

The device 700 may include one or more communication interfaces 706 for exchanging data via the network 110. The communication interfaces 706 can facilitate communications within a wide variety of networks and protocol types, including wired networks (e.g., Ethernet, Data Over Cable Service Interface Specification (DOCSIS), digital subscriber line (DSL), Fiber, universal serial bus (USB) etc.) and wireless networks (e.g., wireless local area network (WLAN), global system for mobile (GSM), code division multiple access (CDMA), 802.11, Bluetooth, Wireless USB, ZigBee, cellular, satellite, etc.), the Internet and the like. Communication interfaces 706 can also provide communication with external storage, such as a storage array, network attached storage, storage area network, cloud storage, or the like.

The display device 708 and the output devices 212 (e.g., virtual reality (VR) headset) may be used for displaying content (e.g., information and images) to users. Other I/O devices 710 and the input devices 210 may be devices that receive various inputs from a user and provide various outputs to the user, and may include a keyboard, a touchpad, a mouse, a gaming controller (e.g., joystick, steering controller, accelerator pedal, brake pedal controller, VR headset, VR glove, or the like), a printer, audio input/output devices, and so forth.

The computer storage media, such as memory 116 and mass storage devices 712, may be used to store software and data, including, for example, the transformer 502, the embedding 504, the input characteristics 410, the distance determination module 408, the creator identifier 302, the creator descriptions 304, the creator embedding 308, the similarity measurements 310, the attribution vector 136, other software 716, and other data 718.

The user 132 (e.g., secondary creator) may use a computing device 720 to provide the input 116, via one or more networks 722, to a server 724 that hosts the generative AI 114. Based on the input 116, the server 724 may provide the output 118. The device 700 may be used to implement the computing device 720, the server 724, or another device.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
determining, by one or more processors, an input provided to a generative artificial intelligence to generate an output;
parsing, by the one or more processors, the input to determine:
a type of content to generate;
a content description; and
one or more creator identifiers;
embedding, by the one or more processors, the input into a shared language-image space using an encoder to create an input embedding;
determining, by the one or more processors, a creator description comprising a creator-based embedding associated with individual creators identified by the one or more creator identifiers;
performing, by the one or more processors, a comparison of the input embedding to the creator-based embedding associated with individual creators;
determining, by the one or more processors and based on the comparison, a distance between a creator embedding of the individual creators and the input embedding;
determining, by the one or more processors, one or more creator attributions based on the distance of an amount of the embedding of the individual creators in the input embedding;
determining, by the one or more processors, a creator attribution vector that includes the one or more creator attributions; and
initiating providing compensation to one or more creators based on the creator attribution vector.

2. The method of claim 1, wherein the generative artificial intelligence comprises:
a latent diffusion model;
a generative adversarial network;
a generative pre-trained transformer;
a variational autoencoders;
a multimodal model; or
any combination thereof.

3. The method of claim 1, further comprising:
selecting a particular creator of the one or more creators;
performing, using a neural network, an analysis of content items created by the particular creator;
determining, based on the analysis, a plurality of captions describing the content items;
creating, based on the plurality of captions, a particular creator description; and
associating the particular creator description with the particular creator.

4. The method of claim 3, wherein:
the neural network is implemented using a Contrastive Language Image Pretraining encoder; and
the encoder comprises a transformer neural network.

5. The method of claim 1, wherein the type of content comprises:
a digital image having an appearance of a work of art;
a digital visual image;
a digital text-based book;
a digital music composition;
a digital video; or
any combination thereof.

6. The method of claim 1, wherein the distance comprises:
a cosine similarity,
a contrastive learning encoding distance;
a simple matching coefficient,
a Hamming distance,
a Jaccard index,
an Orchini similarity,
a Sorensen-Dice coefficient,
a Tanimoto distance,
a Tucker coefficient of congruence,
a Tversky index, or
any combination thereof.

7. A server comprising:
one or more processors;
a non-transitory memory device to store instructions executable by the one or more processors to perform operations comprising:
determining an input provided to a generative artificial intelligence to generate an output;
parsing the input to determine:
a type of content to generate;
a content description; and
one or more creator identifiers;
embedding the input into a shared language-image space using an encoder to create an input embedding;
determining a creator description comprising a creator-based embedding associated with individual creators identified by the one or more creator identifiers;
performing a comparison of the input embedding to the creator-based embedding associated with individual creators;
determining, based on the comparison, a distance of an amount of an embedding of the individual creators in the input embedding;
determining one or more creator attributions based on the distance of the amount of the embedding of the individual creators in the input embedding;
determining a creator attribution vector that includes the one or more creator attributions; and
initiating providing compensation to one or more creators based on the creator attribution vector.

8. The server of claim 7, wherein the generative artificial intelligence comprises:
a latent diffusion model;
a generative adversarial network;
a generative pre-trained transformer;
a variational autoencoders;
a multimodal model; or
any combination thereof.

9. The server of claim 7, further comprising:
selecting a particular creator of the one or more creators;
performing, using a neural network, an analysis of content items created by the particular creator;
determining, based on the analysis, a plurality of captions describing the content items;
creating, based on the plurality of captions, a particular creator description; and
associating the particular creator description with the particular creator.

10. The server of claim 9, wherein:
the neural network is implemented using a Contrastive Language Image Pretraining encoder; and
the encoder comprises a transformer neural network.

11. The server of claim 7, wherein:
the one or more creators comprise one or more artists;
the one or more creators comprise one or more authors;
the one or more creators comprise one or more musicians;
the one or more creators comprise one or more visual content creators; or
any combination thereof.

12. The server of claim 7, wherein the content description comprises:
a noun comprising a name of a living creature, an object, a place, or any combination thereof; and
zero or more adjectives to qualify the noun.

13. The server of claim 7, wherein the distance comprises:
a cosine similarity,
a contrastive learning encoding distance,
a simple matching coefficient,
a Hamming distance,
a Jaccard index,
an Orchini similarity,
a Sorensen-Dice coefficient,
a Tanimoto distance,
Tucker coefficient of congruence,
a Tversky index, or
any combination thereof.

14. A non-transitory computer-readable memory device to store instructions executable by one or more processors to perform operations comprising:
determining an input provided to a generative artificial intelligence to generate an output;
parsing the input to determine:
a type of content to generate;
a content description; and
one or more creator identifiers;
embedding the input into a shared language-image space using an encoder to create an input embedding;
determining a creator description comprising a creator-based embedding associated with individual creators identified by the one or more creator identifiers;
performing a comparison of the input embedding to the creator-based embedding associated with individual creators;
determining, based on the comparison, a distance of an amount of an embedding of the individual creators in the input embedding;
determining one or more creator attributions based on the distance of the amount of the embedding of the individual creators in the input embedding;
determining a creator attribution vector that includes the one or more creator attributions; and
initiating providing compensation to one or more creators based on the creator attribution vector.

15. The non-transitory computer-readable memory device of claim 14, wherein the generative artificial intelligence comprises:
a latent diffusion model;
a generative adversarial network;
a generative pre-trained transformer;
a variational autoencoders;
a multimodal model; or
any combination thereof.

16. The non-transitory computer-readable memory device of claim 14, further comprising:
selecting a particular creator of the one or more creators;
performing, using a neural network, an analysis of content items created by the particular creator;
determining, based on the analysis, a plurality of captions describing the content items;
creating, based on the plurality of captions, a particular creator description; and
associating the particular creator description with the particular creator.

17. The non-transitory computer-readable memory device of claim 14, wherein:
the type of content comprises a digital image having an appearance of a work of art and the one or more creators comprise one or more artists.

18. The non-transitory computer-readable memory device of claim 14, wherein:
the type of content comprises a digital book and the one or more creators comprise one or more authors.

19. The non-transitory computer-readable memory device of claim 14, wherein:
the type of content comprises a digital music composition and the one or more creators comprise one or more musicians.

20. The non-transitory computer-readable memory device of claim 14, wherein:
the type of content comprises visual content and the one or more creators comprise one or more visual content creators.
